(19) United States
(12) Patent Application Publication
(10) Pub. No.: US 2025/0377163 A1
(43) Pub. Date: Dec. 11, 2025

(54) DUAL ELECTRODE DC ELECTRIC ARC MELTER

(71) Applicant: Frederik Petrus GREYLING, Middelburg (ZA)

(72) Inventor: Frederik Petrus GREYLING, Middelburg (ZA)

(21) Appl. No.: 19/205,472

(22) Filed: May 12, 2025

(30) Foreign Application Priority Data
Jun. 10, 2024 (NL) 2037914

(51) Int. Cl. F27D 11/10; F27B 3/08

(52) U.S. Cl. CPC F27D 11/10; F27B 3/085

(57) ABSTRACT

A dual electrode DC electric arc melter 10 for a conductive material 12 comprises a vessel 14 for holding the material. The vessel comprises a sidewall 16, a roof 18 and a bottom 20 and defines a taphole 22 for molten metal. A tilting mechanism 24 enables selective tilting of the vessel to tap the molten metal from the vessel. First 26 and second 28 electrodes, in a normal operative position, extend through the roof into the vessel. An electrode manipulating arrangement 30 is configured to move the electrodes between the normal operative position and a position away from the vessel. A DC power system 32 drives via a DC output the first electrode as a cathode and the second electrode as an anode. An arc deflection compensation circuit 50 is provided for reducing deflection towards the sidewall of arcs extending from the first and second electrodes.

### CROSS-REFERENCE TO RELATED APPLICATION

This application claims priority to Netherlands Patent Application 2037671, filed on May 13, 2024, the disclosure of which is hereby incorporated by reference in its entirety.

### INTRODUCTION AND BACKGROUND

This invention relates to melters, more particularly to a DC electric arc melter for melting a conductive material.

Electrical arc melters are widely used in the world for melting conductive material such as steel scrap, pig iron and direct reduced iron (DRI) pellets. A three electrode AC melter is by far the most widely used. This melter comprises three AC driven electrodes extending through a roof of a vessel holding the material to be melted. Disadvantages of these AC melters are large variations in active power input due to changes in the burden as scrap steel or pig iron moves into the arc zone, a low and rapid varying power factor requiring large transformers, static VAR compensation is required, high levels of flicker and harmonics are introduced into the grid, high noise levels, high graphite electrode consumption and electromagnetic arc deflection towards the vessel sidewalls, leading to hot spots on the sidewalls. Single electrode DC electric arc melters are also known in the art. A single electrode DC electric arc melter comprises a single cathode electrode extending into the vessel and a conductive anode built into a base of the vessel. These melters were introduced to allow for higher power densities and for use in areas where the power grid is not strong enough for the severe impact the above AC melters have on the power grid. However, disadvantages of these single electrode DC melters are substantial downtime and cost of maintaining the base anode, a risk of burn-through associated with the base anode, static VAR compensation is required where DC power is provided with thyristor rectifiers and electromagnetic arc deflection towards the vessel sidewalls. Twin electrode DC electric arc melters are also known in the art. This melter comprises two cathode electrodes in parallel (which allow for higher currents and therefore higher power levels) and a conventional conductive base anode system. Disadvantages of this melter are again substantial down time and cost of maintaining the base anode system, risk of burn-through associated with the base anode, intermittent loss of arc on at least one of the electrodes and static VAR compensation is required, especially when DC power is provided by thyristor-based rectifiers.

### OBJECT OF THE INVENTION

Accordingly, it is an object of the present invention to provide a melter with which the applicant believes the disadvantages of the above known melters may at least be alleviated or which may provide a useful alternative for the known melters.

### SUMMARY OF THE INVENTION

According to the invention there is provided a DC electric arc melter for a conductive material, the DC electric arc melter comprising:
a vessel for receiving and holding the material, the vessel comprising at least one sidewall, a roof and a base, the vessel defining at least a first taphole for molten metal;
a tilting mechanism for the vessel which enables selective tilting of the vessel to tap the molten metal from the vessel through the taphole;
first and second parallel electrodes, which in a normal operative position, extend through the roof into the vessel;
an electrode manipulating arrangement for moving the electrodes between the normal operative position and a position away from the vessel;
a DC power system having a DC output and which system is connected between an AC power source and the electrodes, the DC power system driving via its DC output the first electrode as a cathode and the second electrode as an anode; and
an arc deflection compensation circuit for reducing deflection towards the sidewall of arcs extending from the first and second electrodes.

Hence, there is provided a dual electrode DC electric arc melter comprising parallel cathode and anode electrodes with no conductive structure forming part of or serving as an anode in the base.

In some embodiments the power system may comprise a diode rectifier front-end which is connected at an input thereof to the AC power source and at an output thereof to a chopper which is connected to the DC output of the DC power system.

The chopper may comprise one of insulated-gate bipolar transistors (IGBTs) and integrated gate commutating thyristors (IGCTs) which are pulse width modulation (PWM) controlled.

In another embodiment the power system may comprise a three-phase full bridge which is connected at an input thereof to the AC power source and at an output thereof provides the DC output of the DC power system.

The three-phase full bridge may comprise Integrated Gate Commutating Thyristors (IGCTs) which are pulse width modulation (PWM) controlled.

A DC reactor may be connected between the DC output of the DC power system and at least one of the anode and the cathode.

The arc deflection compensation circuit may comprise a linear conductor located below the base of the vessel and extending parallel to a line perpendicular to and intersecting the first electrode and the second electrode and for carrying a DC compensation current (Ic) in a direction B which is opposite to direction A of DC current flow in the material and between the first electrode and the second electrode.

The conductor may be connected to a DC compensation circuit power supply.

In some embodiments, the DC compensation circuit power supply may form part of said DC power system.

In other embodiments, the DC compensation circuit power supply is different and separate from the DC power system.

Also included within the scope of the present invention is a method of converting a three electrode AC electric arc furnace into a dual electrode DC electric arc furnace, the method comprising the steps of:
removing one of the three electrodes;
providing a DC power system having an input and a DC output; and
connecting the input to an AC power source and the DC output to the remaining two electrodes to drive a first of the two remaining electrodes as a cathode and a second of the two remaining electrodes as an anode thereby to form the dual electrode DC electric arc furnace; and
providing for the dual electrode DC electric arc furnace an arc deflection compensation circuit.

The furnace may be a melter as defied above.

The arc deflection compensation circuit may comprise a linear conductor located below the base of the vessel and extending parallel to a line perpendicular to and intersecting the first and second electrodes, the method may comprise the step of causing a DC compensation current to flow in the conductor in a direction B which is opposite to a direction A of DC current flow in the material between the first electrode and the second electrode.

### BRIEF DESCRIPTION OF THE ACCOMPANYING DIAGRAMS

The invention will now further be described, by way of example only, with reference to the accompanying diagrams wherein:

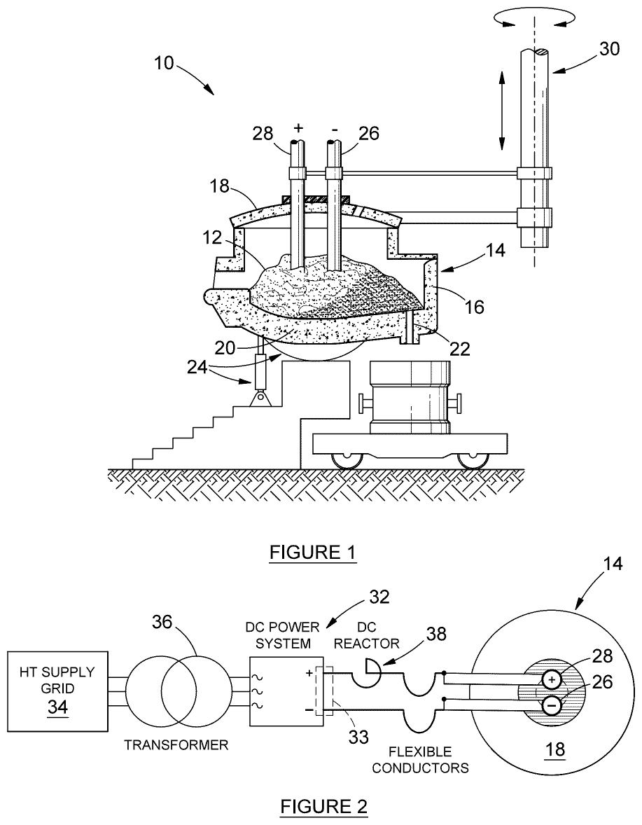

FIG. 1 is a diagrammatic partially sectional view of a dual electrode DC electric arc melter, a vessel of which is charged with conductive material to be melted;

FIG. 2 is a basic block diagram illustrating connection of an anode electrode and a cathode electrode of the melter to a DC power system which in turn is connected to an AC power source;

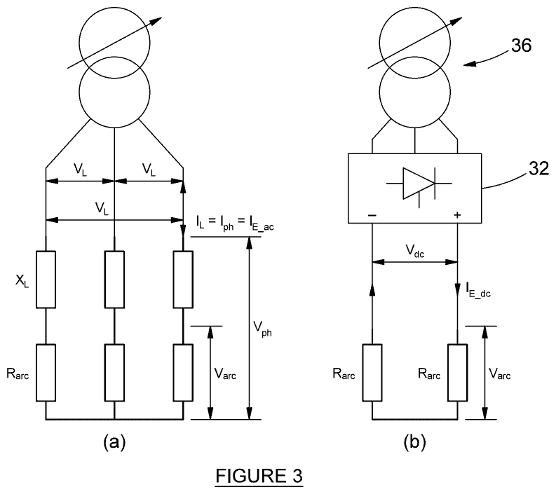

FIG. 3 are equivalent circuits for a three electrode electric AC arc melter on the left and for a dual electrode DC electric arc melter on the right;

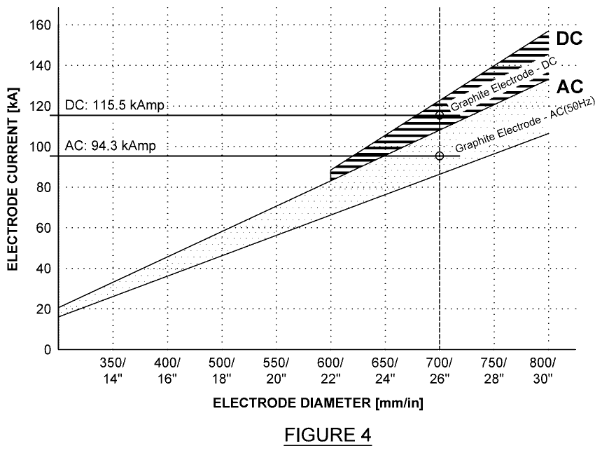

FIG. 4 is a graph of electrode current against electrode diameter;

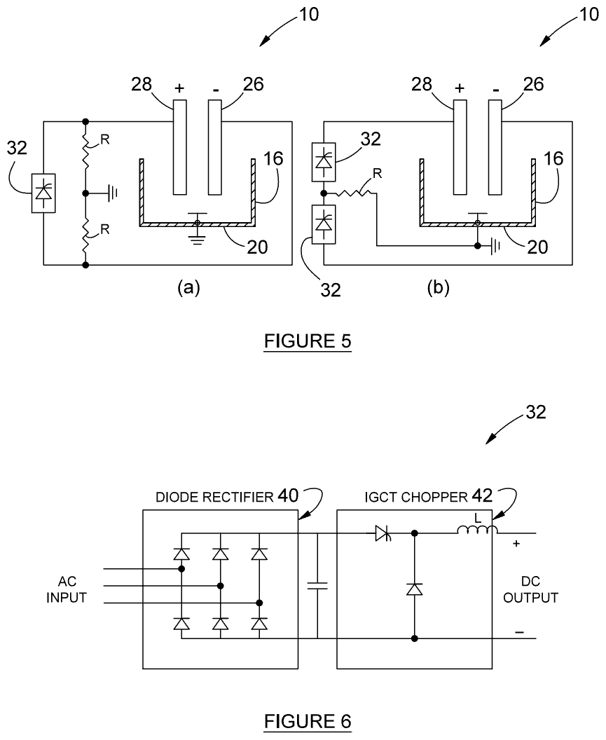

FIG. 5 is a block diagram illustrating first and second alternative DC power system configurations for the dual electrode DC electric arc melter;

FIG. 6 is a block diagram of one example embodiment of a DC power system comprising a rectifier front-end and a DC chopper;

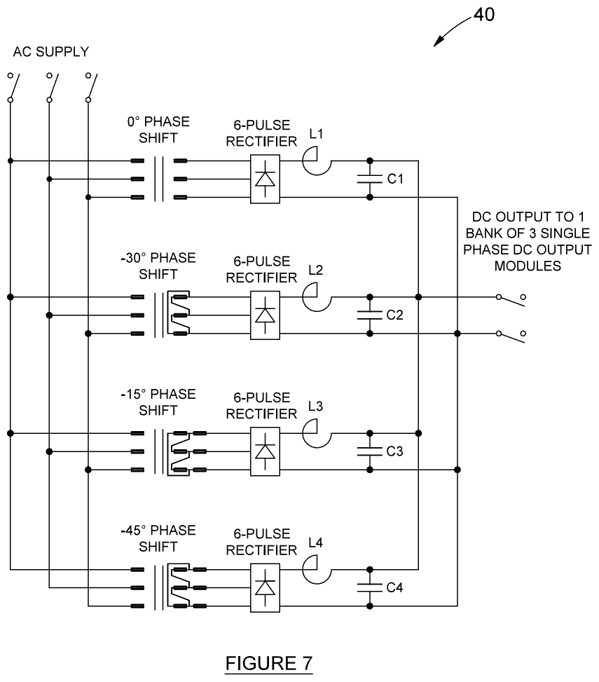

FIG. 7 is a block diagram of one example embodiment of the rectifier front-end;

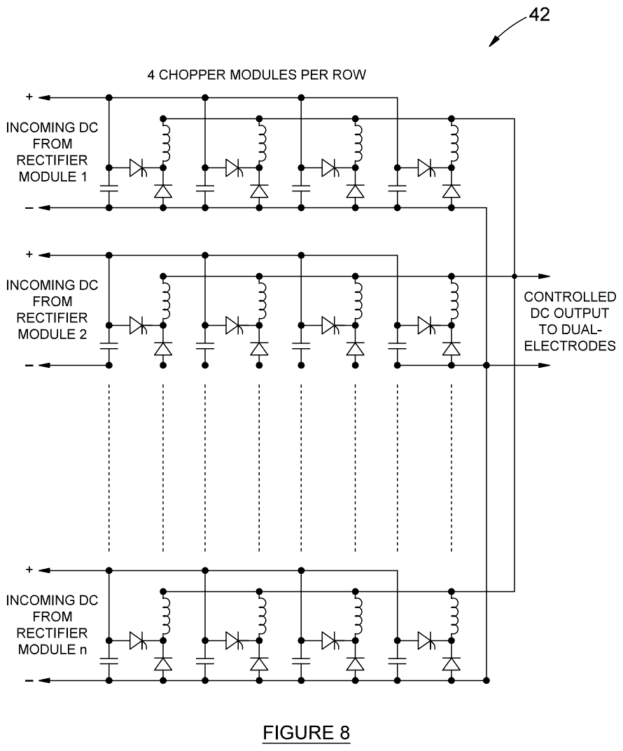

FIG. 8 is a block diagram of one example embodiment of the DC chopper;

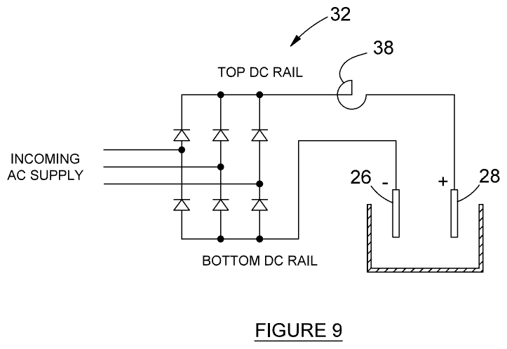

FIG. 9 is a block diagram of a second example embodiment of a DC power system for the dual electrode DC electric arc melter;

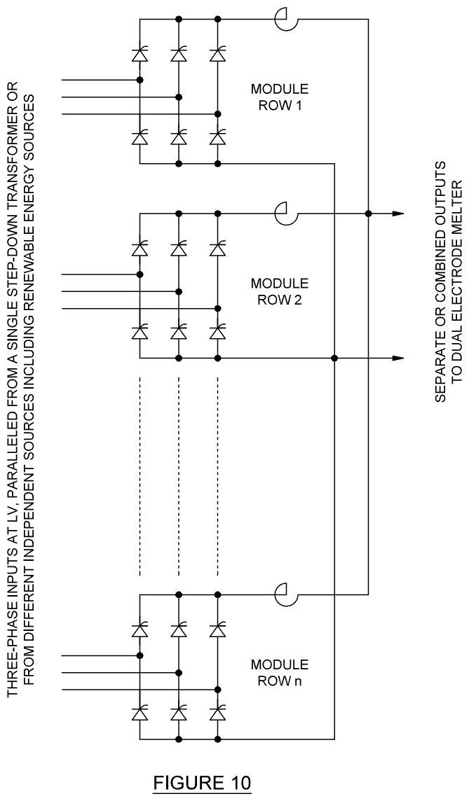

FIG. 10 is a more detailed diagram of the above second embodiment;

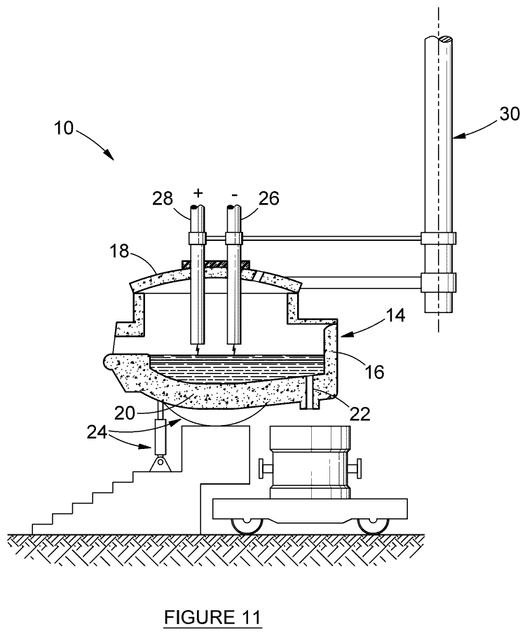

FIG. 11 is a view similar to FIG. 1 of the melter with a bath of molten metal in the vessel;

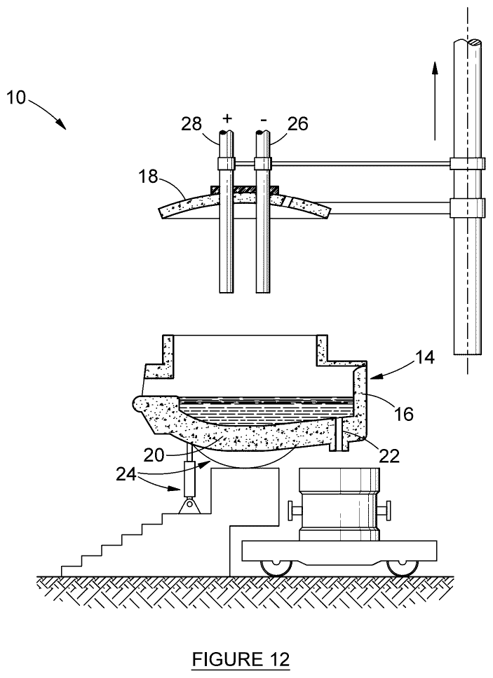

FIG. 12 is a similar view of the melter with a roof, the anode electrode and the cathode electrode manipulated away from the vessel;

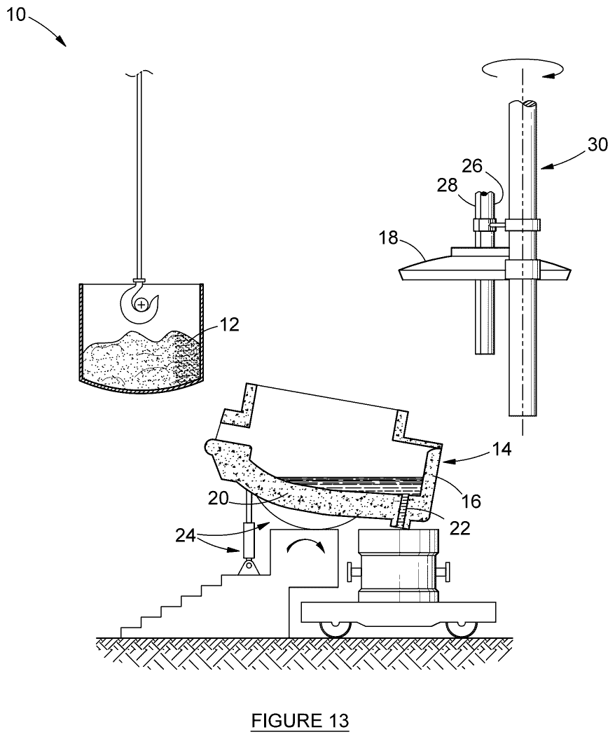

FIG. 13 is a similar view of the melter with the vessel tilted to tap the molten metal through a taphole in the vessel;

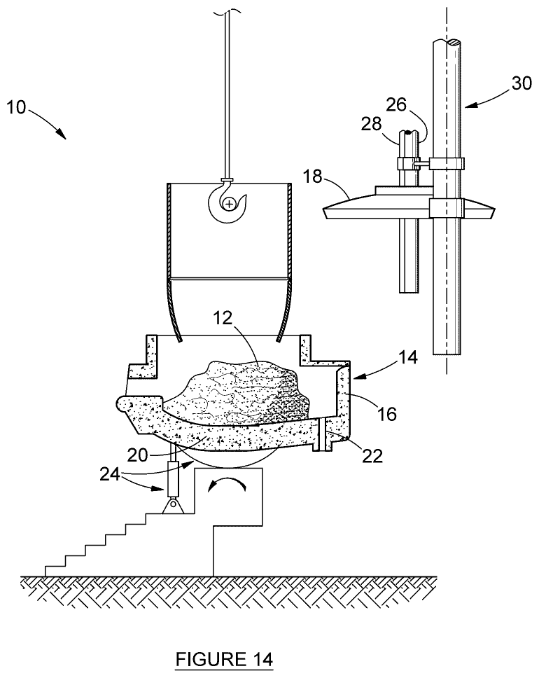

FIG. 14 is a similar view illustrating a step of recharging the vessel with a next batch of conductive material to be melted;

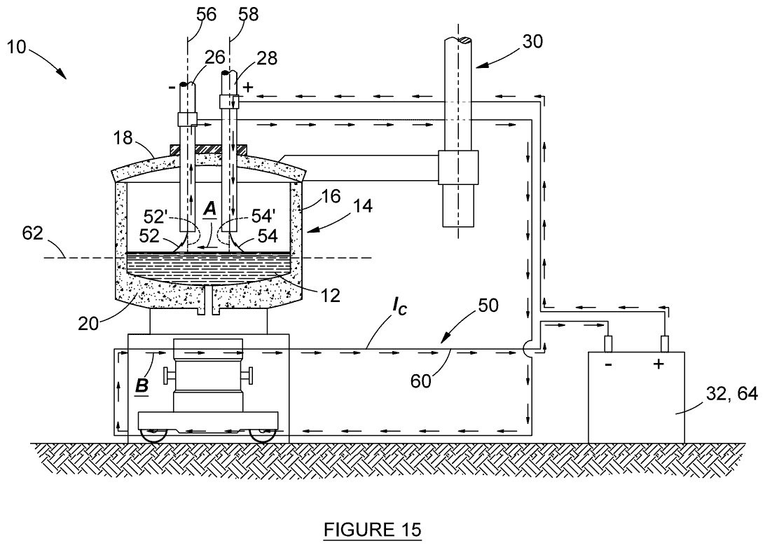

FIG. 15 is a diagrammatic elevational view, partially in section, of another embodiment of the dual electrode DC electric arc melter with an arc deflection compensation circuit;

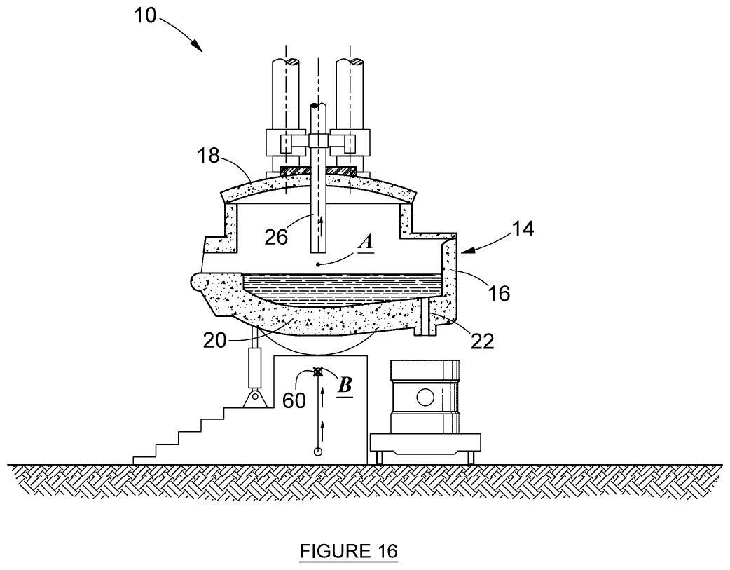

FIG. 16 is a diagrammatic side view, partially in section, of the dual electrode DC electric arc melter in FIG. 15; and

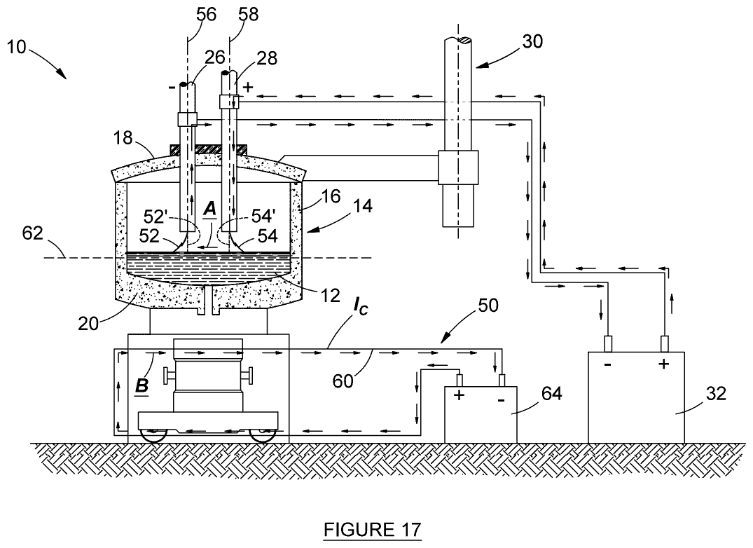

FIG. 17 is a diagrammatic elevational view, partially in section, of yet another embodiment of the dual electrode DC electric arc melter with an arc deflection compensation circuit.

### DESCRIPTION OF A PREFERRED EMBODIMENT OF THE INVENTION

A DC dual electrode electric arc melter is generally designated by the reference numeral 10 in FIGS. 1 and 11 to 17.

A DC dual electrode electric arc melter 10 is used to melt a conductive material 12 (shown in FIGS. 1 and 13 to 17) which may comprise any suitable metal, including but not limited to steel scrap, pig iron and direct reduced iron (DRI) pellets.

The dual electrode DC electric arc melter 10 comprises a vessel 14 for receiving and holding the material 12. The vessel comprises at least one sidewall 16, a removable roof 18 and a base 20. The vessel defines at least a first taphole 22 for molten metal. A tilting mechanism 24 for the vessel enables selective tilting of the vessel (as shown in FIG. 13) to tap the molten metal from the vessel through the taphole. First and second parallel graphite electrodes 26 and 28, in a normal operative position (as shown in FIGS. 1, 11, 15 to 17) extend through the roof 18 into the vessel. An electrode manipulating arrangement 30 is operative to move the electrodes between the normal operative position and a position away from the vessel (as shown in FIGS. 12 to 14). As shown in FIG. 2, a DC power system 32 is connected between an AC power source, such as an electricity supply grid 34, and the electrodes 26 and 28. The DC power system drives, at a DC output 33 thereof, the first electrode 26 as a cathode and the second electrode 28 as an anode. The base 20 is made of an electricity non-conducting material, such as refractory brick, and it does not comprise any conductive part forming part of or serving as an anode. An arc deflection compensation circuit 50 (see FIGS. 15 to 17) is provided for reducing deflection towards the sidewall of arcs extending from the first and second electrodes.

A conventional, non-conductive refractory base or hearth as for AC electric arc furnaces may be used, thereby negating a major disadvantage associated with single and twin-electrode DC electric arc furnaces.

Referring to FIG. 2, a step-down transformer 36 is connected between the HT supply grid 34 and the DC power system 32. An output of the DC power system 32 is connected to a DC reactor 38. The DC reactor assists in “smoothing” the input current in the presence of large stochastic arc current variations and reduce the voltage flicker inflicted on the upstream grid 34. This is an advantage that the DC arc melter power system has above that of the equivalent AC melter.

In FIG. 3 there are shown equivalent circuit diagrams for the known three electrode AC melter (on the left) and a dual electrode DC electric arc melter (on the right). The following calculations illustrate that for the same melter power of 160 MW, although the DC electrode current is higher at 155.5 kA (compared to 94.3 kA for the AC melter) the same size graphite electrode may be used in the DC arc furnace, as illustrated by the graph in FIG. 4.

$$Furnace Power \qquad {P}_{furn} = 160 MW$$

$$Furnace Power Factor \qquad {PF}_{ac} = 0.72 \qquad {PF}_{dc} = 1$$

$$Arc Resistance \qquad {R}_{arc} = ( 6 \cdot {10}^{- 3} ) Ω \qquad {R}_{dc} = 2 \cdot {R}_{arc} = ( 12 \cdot {10}^{- 3} ) Ω$$

$$Electrode current \qquad {I}_{E \_ dc} = \sqrt{\frac{{P}_{furn}}{{R}_{dc}}} = 115.5 kA$$

$$DC Voltage \qquad {V}_{dc =} \sqrt{{P}_{furn} \cdot {R}_{dc}} = 1386 V$$

$$Power per Electrode \qquad {P}_{elec} = \frac{{P}_{furn}}{3} = 53.3 MW$$

$$Electrode current \qquad {I}_{E \_ ac} = \sqrt{\frac{{P}_{elec}}{{R}_{arc}}} = 94.3 kA$$

$$Line voltage \qquad {V}_{l} = \frac{{P}_{furn}}{\sqrt{3} \cdot {I}_{E \_ ac} \cdot {PF}_{ac}} = 1361 V$$

This indicates that an existing three electrode AC electric arc melter (not shown) may be converted into a dual electrode DC electric arc melter 10 by removing one electrode and connecting a DC power system 32 (as more fully described below) between the AC power source or grid 34 and the remaining two electrodes, which are connected to be driven as a cathode 26 and an anode 28, respectively. It is believed that this would be true for other AC electric arc furnaces, such as smelters, as well.

Referring again to FIG. 2, although only a HT supply grid is shown, power may be supplied from different sources such as national power grids, local generated power and renewable energy sources. The incoming power from each source should be separately rectified after step-down from higher voltages, where necessary by 24-pulse or higher multi-phase diode rectifiers, and combined at the DC level. That will enable each of these sources to be separately managed, its power contribution controlled and switched in or out. When combined on the DC side, rather than on the AC side, no synchronization should be necessary and the impact of changing any one feed source on the others should be minimized.

As shown in FIG. 5, there are two alternative schemes for powering the dual-electrode DC electric arc melter 10, namely: a) as shown in FIG. 5(a) using a single galvanically isolated and separately grounded power system; and b) as shown if FIG. 5(b) using twin galvanically isolated and separately grounded power systems. In both cases the short-circuit current magnitude is resistance R-limited and the base 20 is chosen for ground-referencing.

It is believed that for powering 100 MW and larger dual electrode DC melters, there are three options for the power system 32. The first is to use industry-standard 12-pulse conventional thyristor converters which will not be described in more detail below. The second is illustrated in FIG. 6 and employ multi-pulse (12 or 24) diode rectifier front-ends 40 that supply DC to modular switch-mode buck- or booster-choppers 42 based on Integrated Gate Commutating Thyristors (IGCTs). The third is illustrated in FIGS. 9 and 10 and is based on a different power electronic topology to that of the above two. This option can be based on a high-frequency IGCT bridge that fulfils all the functions previously separately provided by converters, rectifiers and IGBT inverters or buck or booster choppers. This option could employ an IGCT-driven, Graetz-bridge to fulfil all the required functions by pulse width modulation (PWM) control.

Referring to FIG. 6, the second option comprises a rectifier front-end 40 to furnish a DC interface to feed the DC buck-chopper 42 that controls output power to the dual electrodes 26, 28. Only a rectifier, and not a phase-controlled converter needs to be used here, because furnace output-voltage and therefore also power-control is provided by the output DC chopper. In addition, the extent of output controlled current range by the DC buck or boost chopper should be sufficient to obviate the necessity for the step-down transformers 36 that supply low voltage (LV), to be equipped with on-load tap changers (OLTCs) which are maintenance intensive devices. It is expected that a high pulse number rectifier, such as the 24-pulse unit, as shown in FIG. 7 would have a close-to-unity fundamental power factor and sufficiently low total harmonic distortion (THD). That may make it unnecessary to incorporate a Static VAr Compensator (SVC) in the system (one that uses passive harmonic filters and a Thyristor Controlled Reactor). Because the total dissipation losses in an SVC could stretch into the MW regime, a system without one would be of great advantage.

A known design of the rectifier front end 40 is shown in FIG. 7. The AC three-phase supply 34 to be rectified is shown on the left, tapped off to four individual phase shift transformers with vector displacements of 0°, −30°, −15° and −45° respectively. These are the fundamental phase displacements needed to furnish phase shifts of 15° at a time, necessary for 24-pulse operation. With 24-pulse operation, the lowest harmonic current that will be injected back into the power network 34 on the AC side will be the 23rd. That harmonic will have an amplitude equal to 1/23rd the magnitude of the fundamental or 4,3% of that of the fundamental. The total harmonic distortion of the current will therefore also be very low.

The switch-mode DC chopper 42 is a static power electronic device that converts a fixed DC voltage to a variable DC voltage. At higher power applications insulated-gate bipolar transistors (IGBTs), insulated-gate bipolar transistor (BJTs), force commutated traditional thyristors and gate turn-off thyristors (GTOs) have been used. The availability of IGCTs now promise high-power applications including the powering of DC arc melters. IGCT based DC choppers have the advantage of high energy efficiency, fast control response, compact size, smooth control and cost-effectivity because of their low component counts. The frequency of switching will depend on the type, specifications or rating of the IGCT used and can lie between 500 Hz for very high-power devices to as much as several kHz for other arrangements.

In practical applications, the duty cycle of switching the IGCTs would be generated by an embedded processor or signal processor device (SPD). The control of the output voltage can then be changed by changing the duty cycle of the switch control signal and that control signal can be generated by different control methods including that of a proportional integral derivative or PID control scheme. An example embodiment of a DC output chopper 42 for the dual electrode DC electric arc melter 10 is shown in FIG. 8. The outputs of the output chopper modules are intended for parallel connection to the dual electrodes 26, 28 in the manner illustrated in FIG. 5.

Total control of power flow to the arcs will be by means of the chopper control signal duty cycle. By virtue of the high switching frequencies that the IGCT are capable of, control of the output power will be very fast and faster than that achievable by means of phase-control and line-commutation as in conventional thyristor converters currently being employed.

Instead of employing separate power electronic structures for rectification 40 and inversion 42 as shown in FIG. 8, the above third option for the DC power system 42 consists of a single structure, that of a three-phase full bridge employing IGCTs and a DC reactor on the DC output side as shown in FIG. 9. The three-phase full bridge should be able to perform all the functions of rectification and output delivery in one.

A more detailed diagram of this option for the DC power system 42 is shown in FIG. 10. This converter uses IGCTs and employ PWM control. The layout is for modules to be supplied with 3-phase power individually from different sources or parallelled to be powered by a common source. The separate sourced power sources may be of different kinds as mentioned above. Because the different systems all supply a common DC bus, no synchronization or interconnection difficulties should exist. All that is required is that the total power input must match the total demand of the melter 10.

Because the IGCT, like the IGBT is a force-commutated device and can be both turned-on and turned-off simply by means of gate signals, the IGCT can be employed as a thyristor to furnish similar behaviour when switched at line frequency, or if it is controlled by PWM signals, it can be controlled either way to rectify AC to DC or to invert DC to full sinusoidal AC. In addition to furnishing DC to the furnace, it can be controlled to perform all the duties already outlined. Using the above type of control can theoretically furnish stochastically varying output DC current while drawing controlled sinusoidal AC input current. By providing DC reactors 38 on the bridge output side, it is theoretically possible to furnish energy buffers to supply stochastically varying DC power to the melter 10 but to draw smooth average AC power from the grid 34.

FIGS. 11 to 14 are self-explanatory and illustrate the known steps of melting the material 12 in the vessel (FIGS. 1 and 11), manipulating by means of electrode manipulating means 30 the roof 18 and electrodes 26, 28 to the position away from the vessel (FIG. 12), utilizing the tilting mechanism 24 to tilt the vessel 14 and to tap the molten metal from the vessel (FIG. 13), tilting the vessel back and recharging the vessel with a next batch of material 12 to be processed (FIG. 14) whereafter the steps generally illustrated in FIGS. 1 and 11 to 14 are cyclically repeated.

Other advantages of the dual electrode DC electric arc melter 10 is that it has been found that the power system 32 provides arcs that are inherently much more stable than AC arcs. The current carrying capacity of a graphite electrode is substantially higher for DC current than for AC current due to the skin-effect derating of AC conductors, as is illustrated by FIG. 4. Arc deflection compensation can be added to the dual-electrode DC configuration, ensuring zero arc deflection, which is not possible with AC electric arc melters. The two electrodes may individually be moved up or down vertically to control the electrode voltage. Substantially lower graphite electrode consumption due to the reduced surface area of two DC electrodes when compared to three AC electrodes is expected.

In FIGS. 15 to 17 there are shown example embodiments of the above arc deflection compensation circuit 50 for reducing outward deflection of arcs 52, 54 extending from the tips of the first and second electrodes respectively to the material 12. The first electrode has a longitudinal axis 56 and the second electrode has a longitudinal axis 58.

It is known that in the arrangement of FIG. 15, a DC electrical current flows from the power supply system 32 through electrode 28 via arc 54 to the material 12, in the material in a first direction A and via arc 52 and cathode 26 to the power supply system. For arc deflection compensation for such an arrangement, a person skilled in the art would expect that diametrically opposed and vertically extending arc deflection compensation conductors (not shown) extending on the outside of the vessel 14 parallel to the electrodes 26, 28, but with currents flowing in directions opposite to the current in the closest electrode and arc, would work. However, such an arrangement of arc deflection compensation conductors is impractical with a tiltable vessel 14, such as that of the melter 10.

Unexpectedly, the applicant has found that a DC compensation current Ic flowing in a compensation conductor 60 forming part of compensation circuit 50 and which conductor 60 is located as close as possible to and below the base 20 and extending parallel to the flow of current in direction A from the anode to the cathode in the material, but in an opposite direction B, provides unexpectedly good arc deflection compensation, so that outwardly deflecting arcs 52, 54 are urged towards the positions 52′ and 54′ shown in FIG. 15. Compensation conductor 60 hence extends parallel to a horizontal line 62 perpendicular to and intersecting the first electrode and second electrode, respectively.

The circuit 50 is connected to a DC compensation power supply 64. In the embodiment of FIGS. 15 and 16 the DC compensation power supply 64 forms part of the DC power system 32.

The example embodiment shown in FIG. 17 is similar to the embodiment of FIGS. 15 and 16, except that in the former case, the DC compensation power supply 64 is separate and independent of the DC power system 32.

1. A dual electrode DC electric arc melter for a conductive material, the dual electrode DC electric arc melter comprising:
a vessel for receiving and holding the material, the vessel comprising at least one sidewall, a roof and a base, the vessel defining at least a first taphole for molten metal;
a tilting mechanism for the vessel which enables selective tilting of the vessel to tap the molten metal from the vessel through the taphole;
first and second parallel electrodes, which in a normal operative position, extend through the roof into the vessel;
an electrode manipulating arrangement for moving the electrodes between the normal operative position and a position away from the vessel;
a DC power system having a DC output and which system is connected between an AC power source and the electrodes; the DC power system driving via its DC output the first electrode as a cathode and the second electrode as an anode; and
an arc deflection compensation circuit for reducing deflection towards the sidewall of arcs extending from the first and second electrodes.

2. The melter as claimed in claim 1 wherein the power system comprises a diode rectifier front-end which is connected at an input thereof to the AC power source and at an output thereof to a chopper which is connected to the DC output of the DC power system.

3. The melter as claimed in claim 2 wherein the chopper comprises one of insulated-gate bipolar transistors (IGBTs) and integrated gate commutating thyristors (IGCTs) which are pulse width modulation (PWM) controlled.

4. The melter as claimed in claim 1 wherein the power system comprises a three-phase full bridge which is connected at an input thereof to the AC power source and at an output thereof provides the DC output of the DC power system.

5. The melter as claimed in claim 4 wherein the three-phase full bridge comprises Integrated Gate Commutating Thyristors (IGCTs) which are pulse width modulation (PWM) controlled.

6. The melter as claimed in claim 1 comprising a DC reactor which is connected between the DC output of the DC power system and at least one of the anode and the cathode.

7. The melter as claimed in claim 1 wherein the arc deflection compensation circuit comprises a conductor located below the base of the vessel and carrying a DC compensation current (Ic) in a direction B which is opposite to direction A of DC current flow in the material and between the first electrode and the second electrode.

8. The melter as claimed in claim 7 wherein the conductor is a linear conductor extending parallel to a line perpendicular to and intersecting the first electrode and the second electrode.

9. The melter as claimed in claim 7 wherein the conductor is connected to a DC compensation circuit power supply.

10. The melter as claimed in claim 9 wherein the DC compensation circuit power supply forms part of said DC power system.

11. The melter as claimed in claim 9 wherein the DC compensation circuit power supply is different and separate from the DC power system.

12. A method of converting a three electrode AC electric arc furnace into a dual electrode DC electric arc furnace, the method comprising the steps of:
removing one of the three electrodes;
providing a DC power system having an input and a DC output;
connecting the input to an AC power source and the DC output to the remaining two electrodes to drive a first of the two remaining electrodes as a cathode and a second of the two remaining electrodes as an anode thereby to form the dual electrode DC electric arc furnace; and
providing for the dual electrode DC electric arc furnace an arc deflection compensation circuit.

13. The method of claim 12 wherein the arc deflection compensation circuit comprises a conductor located below the base of the vessel, the method comprising the step of causing a DC arc compensation current to flow in the conductor in a direction B which is opposite to a direction A of DC current flow in the material between the first electrode and the second electrode.
